(19) United States
(12) Patent Application Publication
(10) Pub. No.: US 2022/0307099 A1
(43) Pub. Date: Sep. 29, 2022

(54) STEEL SHEET HAVING HIGH STRENGTH AND HIGH FORMABILITY AND METHOD FOR MANUFACTURING SAME

(71) Applicant: Hyundai Steel Company, Incheon (KR)

(72) Inventors: Gyu Jin Oh, Incheon (KR); Nam Hoon Goo, Incheon (KR); Kyeong Sik Shin, Incheon (KR); Ho Yong Um, Incheon (KR)

(21) Appl. No.: 17/608,377

(22) PCT Filed: May 15, 2020
(86) PCT No.: PCT/KR2020/006384

§ 371 Date: Nov. 2, 2021

(30) Foreign Application Priority Data
Nov. 20, 2019 (KR) 10-2019-0149189

(51) Int. Cl. C21D 8/02; C22C 38/14; C22C 38/12; C22C 38/06; C22C 38/04; C22C 38/02; C23C 2/40; C23C 2/02

(52) U.S. Cl. CPC C21D 8/0205; C22C 38/14; C22C 38/12; C22C 38/06; C22C 38/04; C22C 38/02; C21D 8/0226; C21D 8/0236; C23C 2/40; C23C 2/02; C21D 2211/001; C21D 2211/005; C21D 2211/008

(57) ABSTRACT

A steel sheet having high strength and high formability according to an aspect of the present invention includes: % by weight, an amount of 0.12-0.22% of carbon (C); an amount of 1.6-2.4% of silicon (Si); an amount of 2.0-3.0% of manganese (Mn); an amount of 0.01-0.05% of aluminum (Al); an amount greater than 0 and less than or equal to 0.05% of the sum of one or more of titanium (Ti), niobium (Nb) and vanadium (V); an amount of 0.015% or less of phosphorus (P); an amount of 0.003% or less of sulfur (S); an amount of 0.006% or less of nitrogen (N); and the reminder of Fe and inevitable impurities, and has a yield strength (YS) of 850 MPa or greater, a tensile strength (TS) of 1180 MPa or greater, an elongation ratio (EL) of 14% or greater, and a hole expansion ratio (HER) or 30% of greater.

### TECHNICAL FIELD

Exemplary embodiments of the present invention relate to a steel sheet and a method for manufacturing the same, and greater particularly, to a steel sheet having high strength and high formability and a method for manufacturing the same.

### BACKGROUND

Recently, from the viewpoint of safety and lightness of a vehicle, the strength of a steel sheet for the vehicle has been greater rapidly increased. In order to secure the safety of passengers, the strength or thickness of steel sheets used as structural members of a vehicle should be increased to secure sufficient impact toughness. In addition, the steel sheets to be applied to vehicle components are required to have sufficient formability, and the weight of the vehicle body is essentially decreased to improve fuel efficiency of the vehicle. Thus, research to continuously strengthen the steel sheet for the vehicle and increase the formability thereof has been conducted.

Currently, as a high-strength steel sheet for the vehicle having the above-mentioned properties, there have been proposed a dual-phase steel that secures strength and an elongation in two phases of ferrite and martensite and a transformation induced plasticity steel that secures strength and an elongation through phase transformation of retained austenite in a final structure during plastic deformation.

As the related art, there is Korean Patent Laid-Open Publication No. 10-2016-0077463 (entitled “Ultra high strength and high ductility steel sheet having superior yield strength and method for manufacturing the same”).

### SUMMARY OF THE INVENTION

### Technical Problem

A problem to be solved by the present invention is to provide a steel sheet having high formability and high strength and a method for manufacturing the same.

### Technical Solution

A steel sheet having high strength and high formability according to an aspect of the present invention includes: % by weight, an amount of 0.12 to 0.22% of carbon (C), an amount of 1.6 to 2.4% of silicon (Si), an amount of 2.0 to 3.0% of manganese (Mn), an amount of 0.01 to 0.05% of aluminum (Al), an amount greater than 0 and less than or equal to 0.05% of the sum of one or more of titanium (Ti), niobium (Nb), and vanadium (V), an amount of 0.015% or less of phosphorus (P), an amount of 0.003% or less of sulfur (S), an amount of 0.006% or less of nitrogen (N), the balance of iron (Fe), and other inevitable impurities, wherein the steel sheet has a yield strength (YS) of 850 MPa or greater, a tensile strength (TS) of 1,180 MPa or greater, an elongation (EL) of 14% or greater, and a hole expansion ratio (HER) of 30% or greater.

In an exemplary embodiment, a final microstructure of the steel sheet may include ferrite, tempered martensite, and retained austenite.

In an exemplary embodiment, in the final microstructure, a volume fraction of the ferrite may be 11 to 20%, a volume fraction of the tempered martensite may be 65% or greater, and a volume fraction of the retained austenite may be 10 to 20%.

In an exemplary embodiment, a grain size of the final microstructure may be less than 5 μm.

In an exemplary embodiment, the product of the tensile strength (TS) and the elongation (EL) may be 20,000 or greater.

A method for manufacturing a steel sheet having high strength and high formability according to an aspect of the present invention includes: (a) manufacturing a hot-rolled sheet using a steel slab containing: % by weight, an amount of 0.12 to 0.22% of carbon (C), an amount of 1.6 to 2.4% of silicon (Si), an amount of 2.0 to 3.0% of manganese (Mn), an amount of 0.01 to 0.05% of aluminum (Al), an amount greater than 0 and less than or equal to 0.05% of the sum of one or more of titanium (Ti), niobium (Nb), and vanadium (V), an amount of 0.015% or less of phosphorus (P), an amount of 0.003% or less of sulfur (S), an amount of 0.006% or less of nitrogen (N), the balance of iron (Fe), and other inevitable impurities; (b) manufacturing a cold-rolled sheet by cold rolling the hot-rolled sheet; (c) performing a primary heat treatment on the cold-rolled sheet at a temperature of (A_{C}3-20) to A_{C}3° C.; (d) sequentially performing slow cooling and quenching on the cold-rolled sheet subjected to the primary heat treatment; and (e) performing a secondary heat treatment by reheating the quenched cold-rolled sheet, wherein after the step (e), the cold-rolled sheet has a final microstructure including ferrite, tempered martensite, and retained austenite.

In an exemplary embodiment, in the final microstructure, a volume fraction of the ferrite may be 11 to 20%, a volume fraction of the tempered martensite may be 65% or greater, and a volume fraction of the retained austenite may be 10 to 20%.

In an exemplary embodiment, the primary heat treatment in the step (c) may be performed at 826 to 846° C.

In an exemplary embodiment, the slow cooling in the step (d) may include cooling the cold-rolled sheet subjected to the primary heat treatment to a temperature of 700 to 800° C. at a cooling rate of 5 to 10° C./s.

In an exemplary embodiment, the quenching in the step (d) may include cooling the slowly cooled cold-rolled sheet to a temperature of 200 to 300° C. at a cooling rate of 50° C./s or greater and maintaining the cooled cold-rolled sheet for 5 to 20 seconds.

In an exemplary embodiment, the secondary heat treatment in the step (e) may include heating the quenched cold-rolled sheet to a temperature of 400 to 460° C. at a temperature increase rate of 10 to 20° C./s and maintaining the heated cold-rolled sheet for 10 to 300 seconds.

In an exemplary embodiment, the manufacturing of the hot-rolled sheet in the step (a) may be performed under conditions of a reheating temperature of 1,150 to 1,250° C., a finishing rolling temperature of 900 to 950° C., and a winding temperature of 550 to 650° C., and the manufacturing of the cold-rolled sheet in the step (b) may be performed under conditions of a cold rolling reduction ratio of 40 to 60%.

In an exemplary embodiment, the method may further include, after the step (e), forming a plating layer by immersing the cold-rolled sheet in a plating bath of 430 to 470° C.

In an exemplary embodiment, the method may further include alloying the plating layer at a temperature of 490 to 530° C.

### Advantageous Effects

According to the present invention, it is possible to implement an ultra-high-strength steel sheet having excellent formability despite high strength by controlling a final microstructure through the process conditions that enable mass production and stably securing a high tensile strength, an appropriate elongation, and a hole expansion ratio (HER), and a manufacturing method of the same. According to an exemplary embodiment of the present invention, it is possible to manufacture a steel sheet having high strength and excellent formability by ideally controlling the fractions of ferrite, martensite, and retained austenite.

### BRIEF DESCRIPTION OF DRAWINGS

FIG. 1 is a flow chart schematically illustrating a method for manufacturing a steel sheet having high strength and high formability according to an exemplary embodiment of the present invention.

FIG. 2 is a photograph illustrating a microstructure of a steel sheet having high strength and high formability according to an exemplary embodiment of the present invention.

### DETAILED DESCRIPTION

Hereinafter, the present invention will be described in detail with reference to the accompanying drawings so as to be easily carried out by a person skilled in the art to which the present invention pertains. The present invention may be implemented in various different forms and is not limited to exemplary embodiments described herein. The same reference numerals are given to the same or similar components throughout the present specification. In addition, detailed descriptions for the well-known functions and configurations that may unnecessarily make the subject matter of the present invention unclear will be omitted.

The use of high-strength, high-ductility, and high-tensile steel has increased for a steel sheet for a vehicle for the purpose of securing the safety of passengers in the event of an accident such as a collision and reducing the weight of a vehicle body according to fuel efficiency regulation. Among components used for a vehicle, members and fillers that affect collision safety have complicated shapes, and thus cannot secure appropriate formability by the mechanical properties (e.g., tensile strength (TS): 980 MPa, elongation (EL): 15%, TS×EL=14,700 MPa %) of a dual-phase (DP) steel that ensures elongation in two phases of existing ferrite and martensite. Therefore, as a high-strength steel sheet that exhibits superior ductility than DP steel, a TRIP steel sheet has attracted attention. Such TRIP steels are classified into various types such as TRIP-type polygonal ferrite steel (TPF steel) containing retained austenite with polygonal ferrite as a main phase and TRIP-type bainite ferrite steel (TBF steel) containing retained austenite with bainitic ferrite as a mother phase. However, the general TRIP steel currently used has reached its limit due to a structure of dual-phase of polygonal ferrite and retained austenite, which cannot escape from the limit of a rule of mixture (ROM), or a structure in which a main matrix is composed of bainite.

The direction of the development of ultra-high-strength steel sheets for a vehicle has attracted attention of each steel manufacturer. As an example, although high strength and high elongation were secured with a composite structure of ferrite, annealed martensite and retained austenite, there is a problem in that a yield ratio (YR) (=YS/TS), which is a ratio of a yield strength (YS) and a tensile strength (TS), is high due to the low fraction of ferrite, resulting in poor processability. In addition, as another example, although high strength and appropriately high formability and processability were secured, there is a disadvantage in that weldability is poor due to a high carbon content. As another example, although a high-strength cold-rolled steel sheet having excellent burring properties was obtained with a composite structure of ferrite, annealed martensite, retained austenite, and bainite, there is a disadvantage in that it is difficult to manufacture the steel sheet in a general continuous galvanizing line (CGL) due to the restriction of heat treatment conditions (e.g., a over-aging section requires a longer time than general CGL).

In the present invention, an ultra-high-strength steel sheet having excellent formability despite high strength by controlling a final microstructure through the process conditions that enable mass production to stably secure a high tensile strength, an appropriate elongation, and a hole expansion ratio (HER), and a manufacturing method of the same will be described. The final microstructure of the steel sheet includes 11 to 20% ultra-fine ferrite, 65% or greater of tempered martensite, and 10 to 20% of retained austenite, and the grain size of each phase may be less than 5 It is preferable that the steel sheet has a yield strength of 800 MPa or greater, a tensile strength of 1,180 MPa or greater, an elongation of 14% or greater, a tensile strength×total elongation value of a final material of about 20,000 or greater, and a hole expansion ratio of 30% or greater.

In addition, alloying elements such as Ti, Nb, and V may be added to form an appropriate amount of carbide, so that the grains of retained austenite may be refined without significant deterioration in the formability and the elongation, which has an advantage in material compensation by properly securing the stability of retained austenite to improve strength, an elongation, and an ability for securing formability of the transformation induced plasticity device. Further, a decrease in the yield strength and the tensile strength due to an increase in a ferrite fraction is suppressed, through refinement of ferrite grains and precipitation hardening due to the presence of precipitates in ferrite. Accordingly, an amount of (Ti+Nb+V) in a component system was adjusted to 0.05 wt % or less.

Hereinafter, a steel sheet having high formability and high strength according to an exemplary embodiment of the present invention having the above-mentioned properties will be described in greater detail.

Steel Sheet Having High Strength and High Formability

A steel sheet having high strength according to an exemplary embodiment of the present invention contains: % by weight, an amount of 0.12 to 0.22% of carbon (C), an amount of 1.6 to 2.4% of silicon (Si), an amount of 2.0 to 3.0% of manganese (Mn), an amount of 0.01 to 0.05% of aluminum (Al), an amount greater than 0 and less than or equal to 0.05% of the sum of one or more of titanium (Ti), niobium (Nb), and vanadium (V), an amount of 0.015% or less of phosphorus (P), an amount of 0.003% or less of sulfur (S), an amount of 0.006% or less of nitrogen (N), the balance of iron (Fe), and other inevitable impurities.

Hereinafter, the role and content of each component contained in the steel sheet having high formability and high strength according to an exemplary embodiment of the present invention will be described in detail. (The content of each component is expressed as wt % of the total steel sheet, and is hereinafter expressed as %).

Carbon (C): 0.12 to 0.22%

Carbon (C) is the most important alloying element in making of steel, and the primary purpose of the carbon in the present invention is to play a basic strengthening role and to stabilize the austenite. A high concentration of carbon (C) in the austenite improves austenite stability, making it easy to secure appropriate austenite for material improvement. However, an excessively high content of carbon (C) may lead to a decrease in weldability due to an increase in carbon equivalent, and a plurality of cementite precipitating structures such as pearlite may be generated during cooling. Thus, it is preferable that carbon (C) is contained in an amount of 0.12 to 0.22% of the total weight of the steel sheet. When carbon (C) is contained in an amount of less than 0.12%, it is difficult to secure the strength of the steel sheet, and when carbon (C) is contained in an amount exceeding 0.22%, weldability may be decreased due to an increase in carbon equivalent, and toughness and ductility may deteriorate.

Silicon (Si): 1.6 to 2.4%

Silicon (Si) is an element that suppresses the formation of carbides in the ferrite, and in particular, is an element that suppresses material degradation due to formation of Fe3C. In addition, silicon (Si) increases the activity of carbon (C) to increase a diffusion rate of the austenite. Silicon (Si) is also known as an element that stabilizes ferrite, and is known as an element that increases ductility by increasing the ferrite fraction during cooling. In addition, silicon (Si) has a very high ability to suppress the formation of carbides, and thus is a necessary element to secure a TRIP effect through an increase in carbon concentration in retained austenite when bainite is formed. If silicon (Si) is added in an amount of less than 1.6%, it is difficult to secure the above effect. On the other hand, if silicon (Si) is added in an amount exceeding 2.4%, oxides (SiO₂) may be formed on the surface of the steel sheet during the process, a rolling load may be increased during hot rolling, and a large amount of red scale may be generated. Therefore, it is preferable to add silicon (Si) in an amount of 1.6% to 2.4% of the total weight of the steel sheet.

Manganese (Mn): 2.0 to 3.0%

Manganese (Mn) is an element that stabilizes austenite. As manganese (Mn) is added, Ms, which is a martensite formation starting temperature, is gradually lowered, thereby increasing a retained austenite fraction during a continuous annealing process.

Manganese (Mn) is contained in an amount of 2.0 to 3.0% of the total weight of the steel sheet. When manganese (Mn) is added in an amount of less than 2.0%, the above-mentioned effect cannot be sufficiently secured. When manganese is added in an amount exceeding 3.0%, plating properties may be decreased due to poor wettability in the corresponding part because the weldability is decreased due to an increase in carbon equivalent, and oxides (MnO) is formed on the surface of the steel sheet during the process.

Aluminum (Al): 0.01 to 0.05%

Like silicon (Si), Aluminum (Al) is known as an element that stabilizes ferrite and suppresses the formation of carbides. In addition, aluminum (Al) has an effect of increasing an equilibrium temperature, so that when it is added, an appropriate heat treatment temperature range is widened. However, if aluminum is added in an amount of less than 0.01%, the above-mentioned effect cannot be implemented, and if aluminum is added in excess in an amount exceeding 0.05%, problems may occur in a continuous casting due to AlN precipitation. Therefore, aluminum may be added in an amount of 0.01 to 0.05% of the total weight of the steel sheet.

Sum of at Least One of Titanium (Ti), Niobium (Nb), and Vanadium (V): Greater than 0 and Less than or Equal to 0.05%

At least one of titanium (Ti), niobium (Nb), and vanadium (V) may be contained in the steel. First, niobium (Nb), titanium (Ti), and vanadium (V) are elements that are precipitated in the form of carbides in steel, and their object in the present invention is to secure stability of retained austenite, improve strength, refine ferrite grains, and conduct precipitation hardening due to the presence of precipitates in ferrite, through refinement of initial austenite grains according to the formation of precipitates. Titanium (Ti) may serve to suppress the formation of AlN to suppress the formation of cracks during continuous casting. However, if the titanium (Ti) is excessively added, there are disadvantages in that coarse precipitates are formed to reduce an amount of carbon in the steel, which causes material deterioration, material degradation, and an increase in a manufacturing cost, etc. Thus, an amount of the titanium (Ti) needs to be adjusted to be greater than 0 and less than or equal to 0.05 wt % of the total of three alloying elements.

Other Elements

Phosphorus (P), sulfur (S), and nitrogen (N) may inevitably be added into the steel during a steelmaking process. That is, ideally, it is preferable that they are not contained, but it is difficult to completely remove them due to process technology, such that a certain small amount thereof may be contained.

Phosphorus (P) may play a role similar to silicon in steel. However, if phosphorus (P) is added in an amount exceeding 0.015% of the total weight of the steel sheet, the weldability of the steel sheet may be decreased and the brittleness thereof may be increased to cause material degradation. Therefore, phosphorus (P) may be controlled to be added in an amount of 0.015% or less of the total weight of the steel sheet.

Sulfur (S) may suppress toughness and weldability in the steel, and thus may be controlled to be contained in an amount of 0.003% or less of the total weight of the steel sheet.

If nitrogen (N) is present in an excessive amount in the steel, a large amount of nitride may be precipitated to degrade ductility. Therefore, nitrogen (N) may be controlled to be contained in an amount of 0.006% or less of the total weight of the steel sheet.

The high-strength steel sheet of the present invention having the alloying components described above has a microstructure including ferrite, tempered martensite, and retained austenite. Here, the volume fraction of the retained austenite in the microstructure may be 10 to 20 vol %. The grains of the high-strength steel sheet may be fine grains each having a size of 5 μm or less.

In the final microstructure of the steel sheet manufactured in the present invention, the ferrite fraction has a great influence on the overall material, and thus, 11 to 20% of the ferrite fraction should be secured, and preferably, 13 to 18% of the ferrite fraction is appropriate. If the ferrite fraction is less than 11%, the yield ratio is high, resulting in a decrease in workability and disadvantageous in securing an elongation. On the other hand, if the ferrite fraction is 20% or greater, it is difficult to secure sufficient strength because the fraction of the tempered structure, which is a matrix structure, is decreased. Retained austenite is preferably present in an amount of 10 to 20% because it is a key structure capable of securing both the strength and elongation of the steel sheet. The tempered martensite may be contained in an amount of 65% or greater to secure strength.

Meanwhile, the microstructure of the high-strength steel sheet of the present invention having the above alloying components, may include at least one of Ti-based precipitates, Nb-based precipitates, and V-based precipitates, and the precipitates may be TiC, NbC and VC. Among the precipitates present within a unit area (1 μm²=1 μm×1 μm) at any point in the steel sheet, a ratio of the precipitates each having a size of 100 nm or less to the precipitates each having a size exceeding 100 nm may be 4:1 or greater and preferably 9:1 or greater. If the ratio is lower than the above ratio, the refinement of grains is not sufficient, which decreases the strength of the steel sheet.

In addition, the number of the precipitates each having a size of 100 nm or less present in the unit area may be 50 to 100. If the number of precipitates each having the size of 100 nm or less exceeds 100, the carbon content in the retained austenite in the final microstructure is decreased, which suppresses the TRIP effect and reduces the strength and elongation. If the number of precipitates each having a size of 100 nm or less is less than 50, the refinement of grain during annealing is insufficient.

Of course, the high-strength steel sheet of the present invention having the alloying components may have a microstructure in which a precipitate ratio is 4:1 to 9:1 or greater within the above-mentioned unit area, and at the same time, and the number of precipitates each having a size of 100 nm or less is 50 to 100.

The precipitates are mainly precipitated in the continuous annealing process of a cold-rolled steel sheet, as will be described later. By controlling the cold-rolled steel sheet containing at least one of titanium (Ti), niobium (Nb), and vanadium (V), but having a total content of greater than 0 and less than or equal to 0.05 wt % at a temperature increase rate of 3 to 10° C./s in the continuous process, the ratio of the precipitates each having a size of 100 nm or less to the precipitates each having a size exceeding 100 nm may be controlled to be 4:1 or 9:1 or greater within an arbitrary unit area, and the number of the precipitates each having a size of 100 nm or less may be controlled to be 50 to 100, which makes it possible to obtain a steel sheet having excellent strength, elongation and hole expansion ratio.

The high-strength steel sheet may have material properties such as yield strength (YS): 850 MPa or greater, tensile strength (TS): 1,180 MPa or greater, elongation (EL): 14% or greater, and hole expansion ratio (HER): 30% or greater. Accordingly, the high-strength steel sheet according to an exemplary embodiment of the present invention may be applied to fields requiring high strength and high formability.

The high-strength steel sheet according to the embodiment of the present invention described above may be manufactured by the method of one embodiment below. The present invention provides a steel sheet having excellent elongation, hole expansion ratio, and strength by performing a continuous annealing process after performing a hot rolling process and a cold rolling process with alloying components having appropriately controlled composition ratios, and a method for manufacturing the same.

Method for Manufacturing Steel Sheet Having High Strength and High Formability

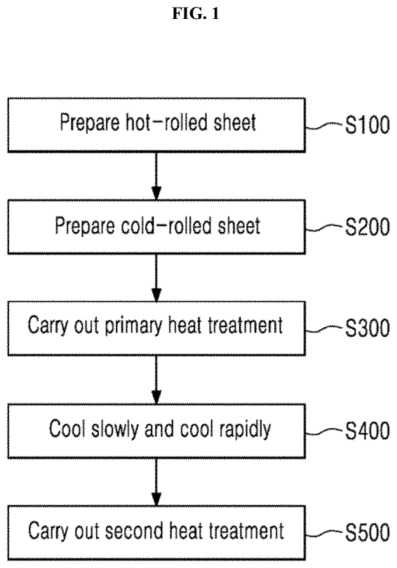

FIG. 1 is a process flow chart schematically illustrating a method for manufacturing a steel sheet having high strength and high formability according to an exemplary embodiment of the present invention.

Referring to FIG. 1, the method for manufacturing a steel sheet includes: a step (S100) of manufacturing a hot-rolled sheet using a steel slab, a step (S200) of manufacturing a cold-rolled sheet by cold rolling the hot-rolled sheet; a step (S300) of performing a primary heat treatment on the cold-rolled sheet; a step (S400) of sequentially performing slow cooling and quenching on the cold-rolled sheet subjected to the primary heat treatment; and a step (S500) of performing a secondary heat treatment by reheating the quenched cold-rolled sheet.

First, in the step (S100) of manufacturing a hot-rolled sheet using a steel slab, the steel slab contains: % by weight, an amount of 0.12 to 0.22% of carbon (C), an amount of 1.6 to 2.4% of silicon (Si), an amount of 2.0 to 3.0% of manganese (Mn), an amount of 0.01 to 0.05% of aluminum (Al), an amount greater than 0 and less than or equal to 0.05% of the sum of one or more of titanium (Ti), niobium (Nb), and vanadium (V), 0.015% or less of phosphorus (P), an amount of 0.003% or less of sulfur (S), an amount of 0.006% or less of nitrogen (N), the balance of iron (Fe), and other inevitable impurities. Further, by adding alloying elements such as Ti, Nb, and V, a decrease in the yield strength and the tensile strength due to an increase in a ferrite fraction is suppressed, through refinement of ferrite grains and precipitation hardening due to the presence of precipitates in ferrite.

Furthermore, the step (S100) of manufacturing a hot-rolled sheet using a steel slab may be performed under the conditions of a reheating temperature of 1,150 to 1,250° C., a finish rolling temperature of 900 to 950° C., and a winding temperature of 550 to 650° C.

A reheating process is a step of re-heating the steel slab to re-dissolve segregated components during casting and homogenizing the components at the time of casting. The reheating temperature of the steel slab is preferably about 1,150 to 1,250° C. so as to secure a normal hot rolling temperature. If the reheating temperature is less than 1,150° C., a problem may arise in that the hot rolling load rapidly increases, and if the reheating temperature exceeds 1,250° C., it may be difficult to secure the strength of a finally produced steel sheet due to coarsening of the initial austenite grains. Subsequently, after reheating the steel slab, hot rolling may be performed in a conventional manner, and finish rolling may be performed at a temperature of 900 to 950° C. to form a hot-rolled sheet. After the finish rolling, the hot-rolled sheet is cooled to 550 to 650° C. at a cooling rate of 10 to 30° C./s and then wound.

Next, the step (S200) of manufacturing a cold-rolled sheet by cold rolling the hot-rolled sheet is a step of pickling and then cold rolling the hot-rolled sheet. The cold rolling is performed to adjust the thickness of the finally produced steel sheet using the hot rolled material, and the hot rolled material is pickled before the cold rolling. Since the microstructure of the finally produced steel sheet is determined in the subsequent continuous annealing process of the final cold-rolled structure, the structure of the hot-rolled material forms an elongated structure. The process proceeds at a reduction ratio of 40 to 60%.

Subsequently, the step (S300) of performing a primary heat treatment on the cold-rolled sheet may be performed under the conditions of a temperature increase rate of 3 to 10° C./s, a starting temperature of (A_{C}3-20) to A_{C}3° C., a holding time of 60 seconds or greater. The temperature of (A_{C}3-20) to A_{C}3° C. in the primary heat treatment step may be, for example, a temperature of 826 to 846° C.

The step (S300) of performing a primary heat treatment is performed under dual-phase domain conditions of austenite and ferrite. In the present invention, the heat treatment is performed in the range of (A_{C}3-20) to A_{C}3° C. in order to obtain a target final material of the steel sheet by securing an appropriate fraction of ferrite and securing ideal ferrite, tempered martensite, and retained austenite in the final microstructure.

In the step (S400) of sequentially performing slow cooling and quenching on the cold-rolled sheet subjected to the primary heat treatment, the slow cooling includes cooling the cold-rolled sheet subjected to the primary heat treatment to a temperature of 700 to 800° C. at a cooling rate of 5 to 10° C./s. That is, after the step (S300) of performing a primary heat treatment (annealing), cooling is performed slowly from 700 to 800° C. at a cooling rate of 5 to 10° C./s, which is to secure the plasticity of the final microstructure by attempting to secure a certain amount of ferrite in the final microstructure during the heat treatment process. Depending on the slow cooling process conditions, microstructures without ferrite may also be formed.

The quenching may include cooling the slowly cooled cold-rolled sheet to a temperature of 200 to 300° C. at a cooling rate of 50° C./s or greater and maintaining the cooled cold-rolled sheet for 5 to 20 seconds. That is, after slow cooling, it is necessary to perform the quenching rapidly at a cooling rate of 50° C./s or greater to a quenching end temperature of 200 to 300° C., which is to easily securing the final material by controlling the quenching end temperature to transform austenite in the microstructure into martensite after slow cooling, and a cooling rate of 50° C./s or greater is required in order to suppress the phase transformation that may occur during the quenching process.

In the step (S500) of performing a secondary heat treatment by reheating the quenched cold-rolled sheet, the secondary heat treatment may include heating the quenched cold-rolled sheet to a temperature of 400 to 460° C. at a temperature increase rate of 10 to 20° C./s and maintaining the heated cold-rolled sheet for 10 to 300 seconds. That is, after the step (S400) of sequentially performing slow cooling and quenching on the cold-rolled sheet subjected to the primary heat treatment, the cold-rolled steel sheet is manufactured by maintaining the cold-rolled sheet for 10 to 300 seconds in a reheating section of 400 to 460° C. and securing strength and elongation through carbon concentration in retained austenite and martensite tempering during the process.

When a cold-rolled and plated steel sheet having a plating layer on at least one surface of the cold-rolled steel sheet is manufactured, a galvanizing step may be added after performing the secondary heat treatment, and the galvanizing step includes immersing the cold-rolled steel sheet in a plating bath of 430 to 470° C. and is performed for 30 to 100 seconds. After the galvanizing step, the plating layer may be alloyed by adding a galvannealing step, and the alloying is performed at a temperature of 490 to 530° C.

A steel sheet having high strength and high formability according to an exemplary embodiment of the present invention may be manufactured through the above-mentioned method.

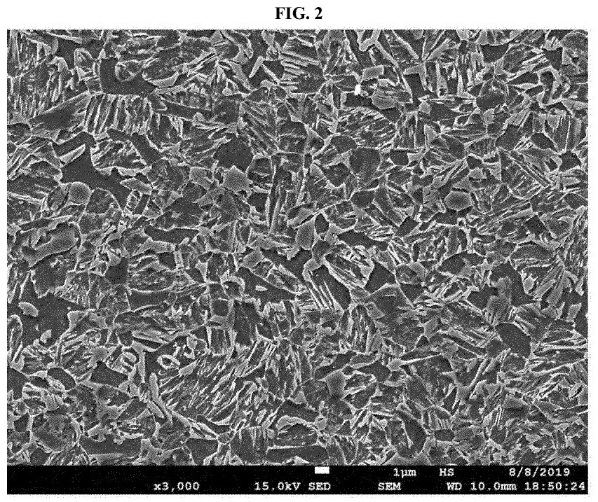

The final microstructure of the steel sheet according to the present invention manufactured by the above process includes, in a volume fraction: 11 to 20% of ultrafine ferrite, 65% or greater of tempered martensite, and 10 to 20% of retained austenite. Referring to FIG. 2, the grains of the high-strength steel sheet may be fine grains having a size of 5 μm or less. In the steel sheet having high strength and high formability according to an exemplary embodiment of the present invention, the ferrite fraction has a great influence on the overall material, and thus, 11 to 20% of the ferrite fraction should be secured, and preferably, 13 to 18% of the ferrite fraction is appropriate. If the ferrite fraction is less than 11%, the yield ratio is high, resulting in a decrease in workability and disadvantageous in securing an elongation. On the other hand, if the ferrite fraction is 20% or greater, it is difficult to secure sufficient strength because the fraction of the tempered structure, which is a matrix structure, is decreased. Retained austenite is preferably present in an amount of 10 to 20% because it is a key structure capable of securing both the strength and elongation of the steel sheet. Meanwhile, the tempered martensite may be contained in an amount of 65% or greater to secure strength.

The material of the steel sheet having high strength and high formability according to an exemplary embodiment of the present invention may have a yield strength of 850 MPa or greater, a tensile strength of 1,180 MPa or greater, an elongation of 14% or greater, a tensile strength×total elongation value of a final material of about 20,000 or greater, and a hole expansion ratio of 30% or greater, and preferably a yield strength of 850 to 1,080 MPa, a tensile strength of 1,180 to 1,300 MPa, an elongation of 14 to 20%, a tensile strength×total elongation value of a final material of about 20,000 or greater, and a hole expansion ratio of 30% or greater. Factors that affect the finally produced steel sheet material include an increase in strength due to the refinement of grains, securing stability of retained austenite, an increase in strength due to precipitation hardening, securing strength and an elongation through phase transformation of retained austenite due to transformation induced plasticity, an increase in strength due to martensite itself, which is a basic matrix, and securing an elongation by ferrite, etc. The final material has a tensile strength×total elongation value of 20,000 or greater, which generally satisfies a proposed value at the corresponding ultra-high strength level, and it can be estimated that the formability will be similar or superior to that of a comparable material having the same strength when the hole expansion ratio is also considered.

### Embodiments of the Invention

Hereinafter, preferable experimental examples showing a configuration and an operation of the present invention in greater detail will be disclosed. However, this is provided as a preferable example of the present invention, and the spirit of the present invention may not be construed as being limited by the following experimental examples.

Table 1 shows the composition (unit: wt %) of the steel sheet according to the experimental example of the present invention.

TABLE 1

| C | Si | Mn | Al | Ti + Nb + V | P | S | N | Fe |
|---|---|---|---|---|---|---|---|---|
| 0.18% | 1.8% | 2.8% | 0.03% | 0.02% | 0.012% | 0.002% | 0.0038% | Bal. |

Referring to Table 1, the composition of the steel sheet according to the experimental example of the present invention includes: % by weight, an amount of 0.18% of carbon (C), an amount of 1.8% of silicon (Si), an amount of 2.8% of manganese (Mn), an amount of 0.03% of aluminum (Al), an amount of 0.02% of the sum of one or more of titanium (Ti), niobium (Nb), and vanadium (V), an amount of 0.012% of phosphorus (P), an amount of 0.002% of sulfur (S), an amount of 0.0038% or nitrogen (N), and the balance of iron (Fe). The composition satisfies a composition range of: % by weight, 0.12 to 0.22% of carbon (C), an amount of 1.6 to 2.4% of silicon (Si), an amount of 2.0 to 3.0% of manganese (Mn), an amount of 0.01 to 0.05% of aluminum (Al), an amount greater than 0 and less than or equal to 0.05% of the sum of one or greater of titanium (Ti), niobium (Nb), and vanadium (V), an amount of 0.015% or less of phosphorus (P), an amount of 0.003% or less of sulfur (S), an amount of 0.006% or less of nitrogen (N), and the balance of iron (Fe). The slab having the alloying components described in Table 1 was subjected to the same hot rolling process and cold rolling process according to the conditions of the Examples of the present invention to manufacture a specimen of a cold-rolled steel sheet. Table 2 shows the continuous annealing process conditions according to the experimental examples of the present invention. The specimens of the cold-rolled steel sheet were processed according to the process conditions shown in Table 2 to manufacture specimens of Comparative Examples 1 and 2 and Example 1.

TABLE 2

| | | | | | \textcircled{5} | | | | |
|---|---|---|---|---|---|---|---|---|---|
| | | \textcircled{2} | \textcircled{3} | \textcircled{4} | Slow | | \textcircled{7} | | \textcircled{9} |
| | \textcircled{1} | Annealing | Annealing | Slow | cooling | \textcircled{6} | Quenching | \textcircled{8} | Reheating |
| | A_{c}3 | starting | holding | cooling | end | Quenching | end | Reheating | holding |
| | temperature | temperature | time | rate | temperature | rate | temperature | temperature | time |
| | (° C.) | (° C.) | (s) | (° C./s) | (° C.) | (° C./s) | (° C.) | (° C.) | (s) |
| Comparative | 846 | 825 | 60 | 7 | 750 | 100 | 250 | 430 | 60 |
| Example 1 | | | | | | | | | |
| Comparative | 846 | 855 | 60 | 7 | 750 | 100 | 250 | 430 | 60 |
| Example 2 | | | | | | | | | |
| Example 1 | 846 | 840 | 60 | 7 | 750 | 100 | 250 | 430 | 60 |

Referring to Table 2, items \textcircled{1} to \textcircled{3} correspond to the primary heat treatment step (S300) illustrated in FIG. 1, items \textcircled{4} to \textcircled{7} correspond to the slow cooling and quenching steps (S400) illustrated in FIG. 1, items \textcircled{8} and \textcircled{9} correspond to the secondary heat treatment step (S500) illustrated in FIG. 1. In Example 1 of Table 2, process conditions for performing the step (S300) of performing a primary heat treatment on the cold-rolled sheet satisfy that a starting temperature is in the range of 826 to 846° C. and a holding time is in the range of 60 seconds or greater, process conditions for performing the step (S400) of sequentially performing slow cooling and quenching on the cold-rolled sheet subjected to the primary heat treatment satisfy that a cooling rate is in the range of 5 to 10° C./s, a slow cooling end temperature is in the range of 700 to 800° C., a quenching rate is in the range of 50° C./s or greater, and a quenching end temperature is in the range of 200 to 300° C., and process conditions for performing the step (S500) of performing a secondary heat treatment by reheating the quenched cold-rolled sheet satisfy that a reheating temperature is in the range of 400 to 460° C., and a reheating holding time is in the range of 10 to 300 seconds.

On the other hand, in Comparative Examples 1 and 2, process conditions for performing the step (S300) of performing a primary heat treatment on the cold-rolled sheet do not satisfy that a starting temperature is in the range of 826 to 846° C. That is, in Comparative Example 1, the primary heat treatment starting temperature is lower than 826° C., and in Comparative Example 2, the primary heat treatment starting temperature is higher than 846° C.

Table 3 shows the final microstructure and material of the steel sheet according to the experimental examples of the present invention.

TABLE 3

| | Retained | Ferrite | Tempered | | | | | | | |
|---|---|---|---|---|---|---|---|---|---|---|
| | γ | α | martensite | YS | TS | | T.EL | U.EL | TS × T.EL | λ(HER) |
| | (%) | (%) | (%) | (MPa) | (MPa) | YR | (%) | (%) | (MPa × %) | (%) |
| Comparative | 14.50 | 22.3 | 63.2 | 843 | 1178 | 0.72 | 17.1 | 16.1 | 20144 | 24 |
| Example 1 | | | | | | | | | | |
| Comparative | 11.09 | 5.8 | 83.11 | 1091 | 1257 | 0.87 | 14.4 | 8.4 | 18101 | 37.5 |
| Example 2 | | | | | | | | | | |
| Example 1 | 14.55 | 15.7 | 71.75 | 909 | 1254 | 0.72 | 16.5 | 10.6 | 20691 | 34.0 |

Referring to Table 3, the steel sheet of Example 1 satisfies that in the final microstructure, the volume fraction of the ferrite α is in the rang of 11 to 20%, the volume fraction of the tempered martensite is in the range of 65% or greater, and the volume fraction of the retained γ is in the range of 10 to 20%. In addition, the steel sheet satisfies that a yield strength (YS) is the range of 850 MPa or greater, a tensile strength (TS) is the range of 1,180 MPa or greater, an elongation (T.EL) is the range of 14% or greater, a hole expansion ratio (HER) is the range of 30% or greater, and product of a tensile strength (TS) and an elongation (T.EL) is the range of 20,000 or greater.

On the other hand, the steel sheet of Comparative Example 1 does not satisfy that the volume fraction of the tempered martensite in the final microstructure is in the range of 65% or greater, a yield strength (YS) is in the range of 850 MPa or greater, a tensile strength (TS) is in the range of 1,180 MPa or greater, and a hole expansion ratio (HER) is in the range of 30% or greater, respectively. And, the steel sheet of Comparative Example 2 does not satisfy that the volume fraction of the ferrite α in the final microstructure is in the range of 11 to 20%, and the product of a tensile strength (TS) and an elongation (T.EL) is in the range of 20,000 or greater.

That is, the steel sheet of Comparative Example 1 subjected to a dual-phase domain annealing process at an annealing temperature of 825° C. showed a relatively high elongation, but did not reach the target material due to a low yield strength (YS) and a low hole expansion ratio (HER). A high elongation was secured by the high ferrite fraction, but the strength was decreased because the tempered martensite was not sufficiently secured. In addition, it is considered that the hole expansion ratio has decreased due to the increase in an interface between ferrite and tempered martensite with a large difference in hardness between phases.

The steel sheet of Comparative Example 2 subjected to a single-phase domain annealing process section at an annealing temperature of 855° C. had a yield strength of 850 MPa or greater, a tensile strength of 1,180 MPa or greater, an elongation of 14% or greater, and a hole expansion ratio of 30% or greater, but did not satisfy a tensile strength×total elongation value of a final material of about 20,000 or greater. This is considered to be because a sufficient fraction of ferrite was not secured.

On the other hand, it can be seen that the steel sheet of Example 1 subjected to the process section at an annealing temperature of 840° C., which is a temperature directly below A_{C}3, had excellent yield strength, tensile strength and elongation, and a hole expansion ratio. In addition, the yield ratio thereof is low, so processability is excellent. This is considered to be due to the formation of ideal ferrite, tempered martensite, and retained austenite microstructures developed under appropriate process conditions.

Although the above description has been focused on the embodiments of the present invention, various changes or modifications may be made at the level of those skilled in the art. Such changes and modifications can be said to belong to the present invention unless they deviate from the scope of the present invention. Accordingly, the scope of the present invention should be judged by the claims described below.

1. A steel sheet having high strength and high formability, the steel sheet comprising: % by weight
an amount of 0.12 to 0.22% of carbon (C), an amount of 1.6 to 2.4% of silicon (Si), an amount of 2.0 to 3.0% of manganese (Mn), an amount of 0.01 to 0.05% of aluminum (Al), an amount greater than 0 and less than or equal to 0.05% of the sum of one or more of titanium (Ti), niobium (Nb), and vanadium (V), 0.015% or less of phosphorus (P), an amount of 0.003% or less of sulfur (S), an amount of 0.006% or less of nitrogen (N), and the balance of iron (Fe), and other inevitable impurities, % by weight,
wherein the steel sheet has a yield strength (YS) of 850 MPa or greater, a tensile strength (TS) of 1,180 MPa or greater, an elongation (EL) of 14% or greater, and a hole expansion ratio (HER) of 30% or greater.

2. The steel sheet of claim 1, wherein a final microstructure of the steel sheet comprises ferrite, tempered martensite, and retained austenite.

3. The steel sheet of claim 2, wherein in the final microstructure, a volume fraction of the ferrite is 11 to 20%, a volume fraction of the tempered martensite is 65% or greater, and a volume fraction of the retained austenite is 10 to 20%.

4. The steel sheet of claim 3, wherein a grain size of the final microstructure is less than 5 μm.

5. The steel sheet of claim 1, wherein the product of the tensile strength (TS) and the elongation (EL) is 20,000 or greater.

6. A method for manufacturing a steel sheet having high strength and high formability, the method comprising:
(a) manufacturing a hot-rolled sheet using a steel slab containing: % by weight, an amount of 0.12 to 0.22% of carbon (C), an amount of 1.6 to 2.4% of silicon (Si), an amount of 2.0 to 3.0% of manganese (Mn), an amount of 0.01 to 0.05% of aluminum (Al), an amount greater than 0 and less than or equal to 0.05% of the sum of one or more of titanium (Ti), niobium (Nb), and vanadium (V), an amount of 0.015% or less of phosphorus (P), an amount of 0.003% or less of sulfur (S), an amount of 0.006% or less of nitrogen (N), and the balance of iron (Fe) and other inevitable impurities;
(b) manufacturing a cold-rolled sheet by cold rolling the hot-rolled sheet;
(c) performing a primary heat treatment on the cold-rolled sheet at a temperature of (A_{C}3-20) to A_{C}3° C.;
(d) sequentially performing slow cooling and quenching on the cold-rolled sheet subjected to the primary heat treatment; and
(e) performing a secondary heat treatment by reheating the quenched cold-rolled sheet,
wherein after the step (e), the cold-rolled sheet has a final microstructure including ferrite, tempered martensite, and retained austenite.

7. The method of claim 6, wherein in the final microstructure, a volume fraction of the ferrite is 11 to 20%, a volume fraction of the tempered martensite is 65% or greater, and a volume fraction of the retained austenite is 10 to 20%.

8. The method of claim 6, wherein the primary heat treatment in the step (c) is performed at 826 to 846° C.

9. The method of claim 6, wherein the slow cooling in the step (d) includes cooling the cold-rolled sheet subjected to the primary heat treatment to a temperature of 700 to 800° C. at a cooling rate of 5 to 10° C./s.

10. The method of claim 6, wherein the quenching in the step (d) includes cooling the slowly cooled cold-rolled sheet to a temperature of 200 to 300° C. at a cooling rate of 50° C./s or greater and maintaining the cooled cold-rolled sheet for 5 to 20 seconds.

11. The method of claim 6, wherein the secondary heat treatment in the step (e) includes heating the quenched cold-rolled sheet to a temperature of 400 to 460° C. at a temperature increase rate of 10 to 20° C./s and maintaining the heated cold-rolled sheet for 10 to 300 seconds.

12. The method of claim 6, wherein the manufacturing of the hot-rolled sheet in the step (a) is performed under conditions of a reheating temperature of 1,150 to 1,250° C., a finishing rolling temperature of 900 to 950° C., and a winding temperature of 550 to 650° C., and
the manufacturing of the cold-rolled sheet in the step (b) is performed under conditions of a cold rolling reduction ratio of 40 to 60%.

13. The method of claim 6, further comprising, after the step (e), forming a plating layer by immersing the cold-rolled sheet in a plating bath of 430 to 470° C.

14. The method of claim 13, further comprising alloying the plating layer at a temperature of 490 to 530° C.
